(19) United States
(12) Patent Application Publication
(10) Pub. No.: US 2006/0187161 A1
(43) Pub. Date: Aug. 24, 2006

(54) Field sequential driving method and field sequential liquid crystal display

(76) Inventor: Takeshi Okuno, Ulsan (KR)

Correspondence Address: CHRISTIE, PARKER & HALE, LLP, PO BOX 7068, PASADENA, CA, 91109-7068, US

(21) Appl. No.: 11/329,828

(22) Filed: Jan. 10, 2006

(30) Foreign Application Priority Data
Feb. 18, 2005 (KR) 2005-13750

(51) Int. Cl. G09G 3/36

(52) U.S. Cl. 345/88

(57) ABSTRACT

A field sequential LCD and a method of initializing a liquid crystal using the same are provided. A reset voltage having a higher voltage level than a data signal is applied to initialize the liquid crystal. Accordingly, the field sequential LCD includes a reset voltage generator to generate the reset voltage having a higher voltage level than the data signal. The reset voltage is applied to the liquid crystal according to a selection operation of the source driver.

### CROSS-REFERENCE TO RELATED APPLICATION

This application claims priority to and the benefit of Korean Patent Application No. 2005-13750, filed Feb. 18, 2005, which is incorporated herein by reference in its entirety.

### FIELD OF THE INVENTION

The present invention relates to a method of driving a liquid crystal display (LCD) and an LCD using the method, and more particularly, to a field sequential driving method and a field sequential LCD.

### BACKGROUND

Unlike a typical thin film transistor (TFT) LCD, which includes red, green and blue color filters and uses white light as a light source of a backlight, a field sequential LCD does not necessarily include a color filter.

The field sequential LCD includes a red lamp, a green lamp, and a blue lamp, instead of the color filters. The three color lamps are provided corresponding to a liquid crystal for each pixel and are turned on in sequence to display an image with a predetermined color.

Accordingly, in a typical field sequential LCD, three sub-frames are required for one frame. The three sub-frames include a red (R)-frame, a green (G)-frame, and a blue (B)-frame.

Each sub-frame has a reset period and a data programming period. During the reset period, the liquid crystal is initialized. During the data programming period, the initialized liquid crystal is aligned corresponding to a data voltage. When the liquid crystal has a predetermined alignment corresponding to the data voltage, the lamp corresponding to the sub-frame is turned on. In other words, the liquid crystal is first initialized, and then the data voltage is applied to the initialized liquid crystal. Then, the liquid crystal is aligned in response to the data voltage, and the lamp is turned on while the data voltage applied to a pixel electrode of the liquid crystal is maintained for a predetermined duration, thereby illuminating the liquid crystal with the light emitted from one of the three lamps corresponding to the sub-frame.

However, the field sequential LCD has a remarkably short reset period compared with the typical TFT LCD. In the field sequential LCD, the three sub-frames are provided within one frame, and therefore three reset periods are needed for one frame. Accordingly, the resetting operation of the field sequential LCD should be quickly performed compared with the typical TFT LCD, in consideration of a response time of the liquid crystal to the data voltage.

FIG. 1A is a timing diagram illustrating a conventional method of applying a reset voltage to a field sequential LCD. For example, in the case of an R-frame during which a red lamp is turned on, initialization of the liquid crystal begins at the beginning of the R-frame. To initialize the liquid crystal, a square wave is periodically applied to the liquid crystal. That is, a plurality of square waves are applied to the liquid crystal during a reset period of Δt1 to initialize the liquid crystal. Here, the square waves have a voltage level of ΔV.

When the reset period ends, a data programming period begins. During the data programming period, a data signal applied from a data driver has the form of a square wave. According to an embodiment of the conventional method, the square wave may be a pulse-width modulated signal. During the data programming period, the square waves of the data signal also have a voltage level of ΔV. Thus, the level of the square waves used for initialization is substantially equal to the level of the square waves of the data signal.

In the field sequential driving method, the reset period is shorter than in the TFT LCD. Thus, the liquid crystal may not be sufficiently initialized during the reset period.

FIG. 1B is a graph illustrating transmittance with respect to the timing diagram of FIG. 1A.

As shown, one frame is divided into three sub-frames, e.g., an R-frame, a G-frame, and a B-frame. Each sub-frame includes a reset period and a data programming period.

For example, the R-frame includes the R-reset period and the R-data programming period. During the R-reset period, a square wave is applied to the liquid crystal for initialization. Here, the reset period is too short to completely initialize the liquid crystal and as a result, the transmittance of the liquid crystal is not sufficiently lowered and remains at a predetermined level.

Here, the arrangement of the liquid crystal depends on the voltage difference between a pixel electrode and a common electrode of the liquid crystal. Hence, when the R-data programming period begins in a state where the liquid crystal is not completely initialized, the liquid crystal is aligned to have a higher transmittance than desired. Therefore, even though a normal data signal is applied to the liquid crystal, the liquid crystal has a higher transmittance than desired transmittance because the liquid crystal is not completely initialized and its transmittance remains at a predetermined level.

This phenomenon occurs in the G-frame and the B-frame as well. The reason that the liquid crystal is not sufficiently initialized is because the square waves for initializing the liquid crystal have the same voltage level as the voltage level of the square waves of the data signal. Therefore, in the field sequential driving method, when square waves having the same voltage level as the data signal are applied for initializing the liquid crystal in a state where each sub-frame has an insufficient reset period, problems arise in that the liquid crystal is not completely initialized and thus a desired gradation is not properly displayed.

### SUMMARY OF THE INVENTION

The present invention provides a field sequential driving method in which a signal voltage having a higher voltage level than a data signal is applied to initialize a liquid crystal.

The present invention also provides a field sequential LCD in which a reset signal having a higher voltage level than a data signal is applied for initializing a liquid crystal.

In an exemplary embodiment of the present invention, in a field sequential driving method of driving a liquid crystal by activating three sub-frames in sequence, each sub-frame includes: applying a reset voltage having a first level to initialize the liquid crystal; applying a data signal having a second level that is lower than the first level to the liquid crystal; and emitting light to the liquid crystal receiving the data signal.

In another exemplary embodiment of the present invention, a field sequential LCD includes: an LCD panel displaying an image; a gate driver supplying a scan signal to the LCD panel; a source driver supplying a data signal to the LCD panel during a data programming period and supplying a reset voltage to the LCD panel during a reset period; a timing controller receiving digital video data and synchronization signals and generating a control signal and the data signal for displaying an image in response to the synchronization signal; a gradation voltage generator receiving the data signal from the timing controller and supplying data modulated based on a lookup table to the source driver; a reset voltage generator generating the reset voltage having a higher level than the data signal in response to a control signal of the timing controller and supplying the reset voltage to the source driver; a light source controller generating a light control signal in response to the control signal of the timing controller; and a light emitter having a plurality of lamps and emitting light in response to the light control signal of the light source controller.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention:

FIG. 1A is a timing diagram illustrating a conventional method of applying a reset voltage to a field sequential LCD;

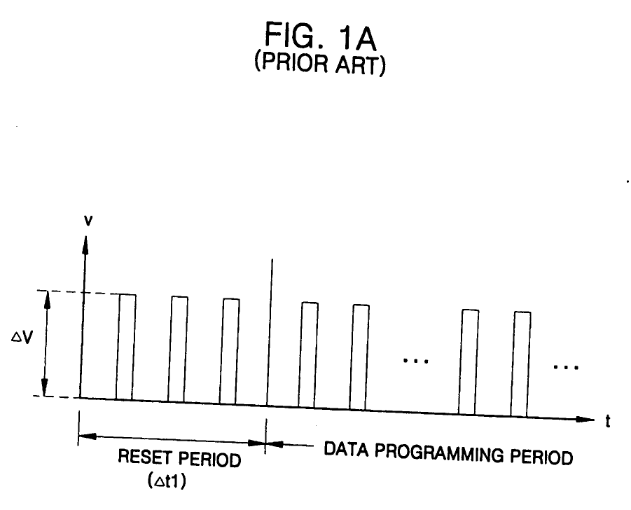

FIG. 1B is a graph illustrating transmittance with respect to the timing diagram of FIG. 1A;

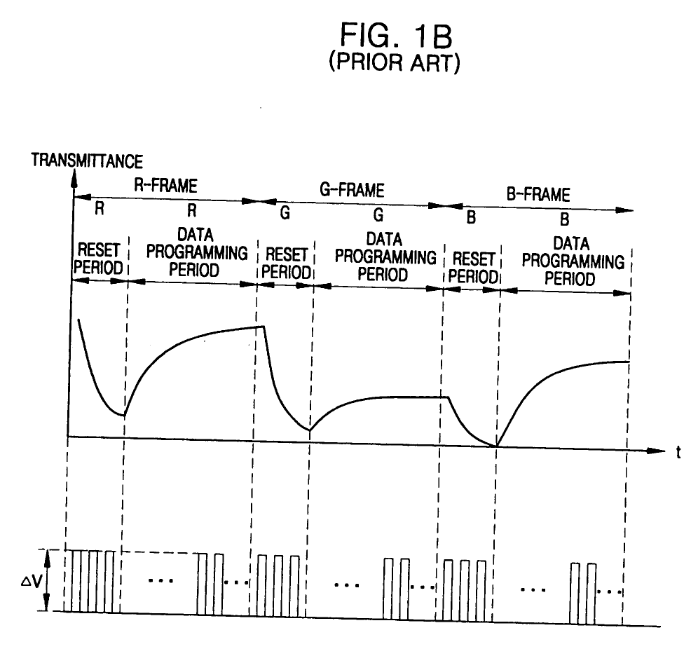

FIG. 2A is a timing diagram illustrating a method of applying a reset signal to a field sequential LCD according to a first embodiment of the present invention;

FIG. 2B is a graph illustrating transmittance with respect to the timing diagram of FIG. 2A; and

FIG. 3 is a block diagram of a field sequential LCD performing initialization of a liquid crystal according to a second embodiment of the present invention.

### DETAILED DESCRIPTION OF THE INVENTION

The present invention will now be described more fully with reference to the accompanying drawings, in which exemplary embodiments of the invention are shown. This invention may, however, be embodied in different forms and should not be construed as limited to the embodiments set forth herein.

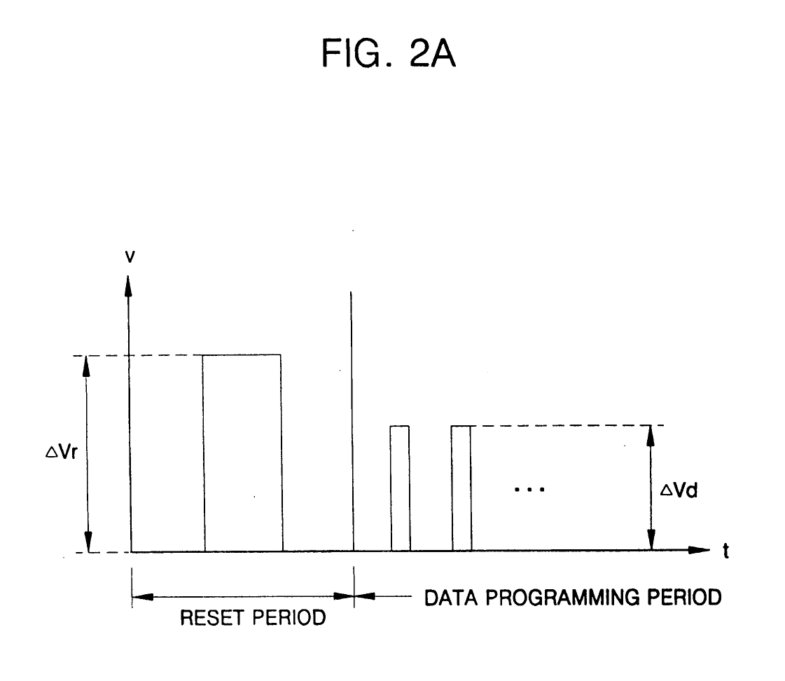

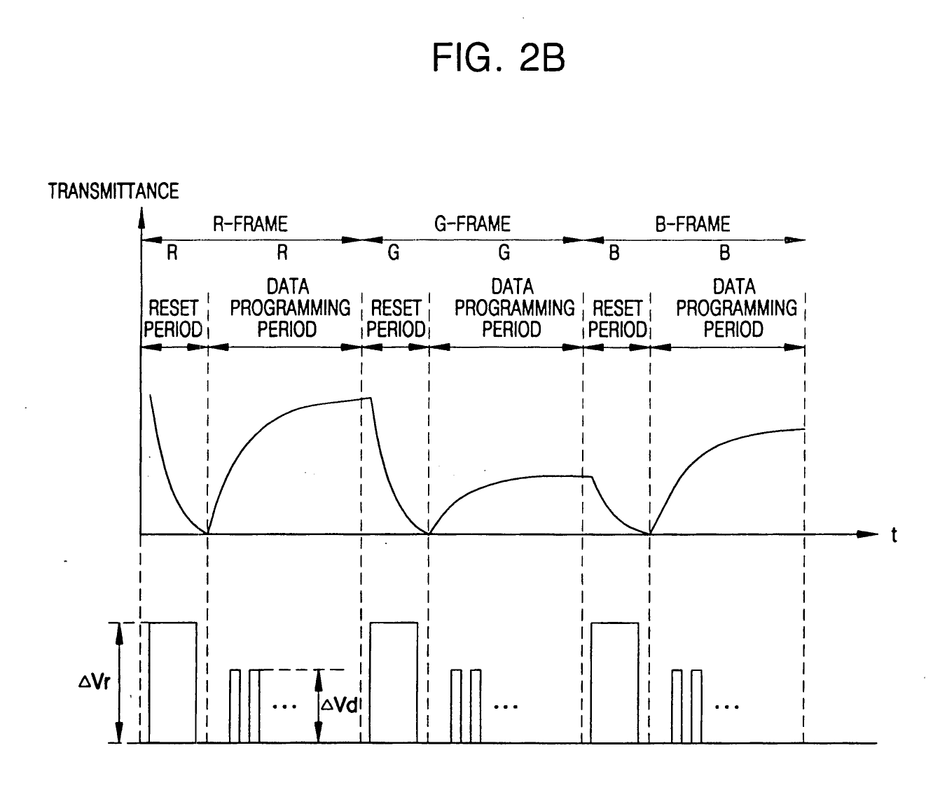

FIG. 2A is a timing diagram illustrating a method of applying a reset voltage according to a first embodiment of the present invention. As shown, a reset period and a data programming period occur during a sub-frame. During the reset period, a reset voltage is applied to a pixel. Here, the reset voltage has a level of ΔVr which is higher than a voltage level ΔVd of a data signal applied to the pixel during the data programming period. That is, a square wave used as the reset voltage has a higher voltage level (ΔVr) than the data signal (ΔVd).

Further, the width of the square wave used as the reset voltage is equal to or smaller than the duration of the reset period. In other words, a single square wave having a voltage level of ΔVr is applied to the pixel for the duration of the reset period. Alternatively, two or more square waves having a level of ΔVr are applied to the pixel.

When the reset voltage having a higher voltage level than the data signal is applied to the pixel, the pixel is more quickly initialized than when the reset voltage has the same level as the data signal. Thus, the time required to initialize the liquid crystal is reduced.

When the reset period ends, the data programming period begins. During the data programming period, the data signal having a voltage level of ΔVd is applied to the liquid crystal so that the liquid crystal is realigned corresponding to the voltage level and the duration of the applied data signal. Accordingly, the liquid crystal has a predetermined transmittance based on its alignment. One of a red lamp, a green lamp and a blue lamp is turned on corresponding to the liquid crystal having a predetermined transmittance to display an image.

Here, the data signal may be a pulse width modulated signal. Further, the square wave of the data signal has a variable width which is controlled to include a predetermined gradation.

FIG. 2B is a graph illustrating transmittance with respect to the timing diagram of FIG. 2A. Referring to FIG. 2B, one frame is divided into three sub-frames; e.g., an R-frame, a G-frame, and a B-frame. Each sub-frame includes a reset period and a data programming period.

For example, the R-frame includes an R-reset period and an R-data programming period. During the R-reset period, the pixel is sufficiently initialized by the applied reset voltage. The reset voltage is set to have a level of ΔVr which is higher than the voltage level ΔVd of the data signal. The initialization of the pixel depends on the level and the duration of the reset voltage applied to the pixel. Thus, when the reset voltage has the level of ΔVr which is higher than the voltage level ΔVd of the data signal, the pixel is easily initialized.

Further, as shown in FIG. 2A, the reset voltage includes one square wave. Alternatively, two or more square waves may be sequentially applied at predetermined intervals as the reset voltage. During each sub-frame, the reset voltage has a higher level than the voltage level of the data signal, and may be applied in the form of a single square wave or two or more square waves.

According to an embodiment of the present invention, when the reset voltage is applied to the pixel, the pixel is sufficiently initialized. Thus, the transmittance of the pixel is sufficiently lowered to completely initialize the liquid crystal at the end point of the reset period.

Following the R-reset period, the R-data programming period begins. During the R-data programming period, an R-data signal is applied to the pixel. Here, the R-data signal has a voltage level of ΔVd and is applied in the form of a square wave to the pixel. In FIG. 2B, the R-data signal has a constant high-level section at predetermined intervals, but it is not restricted to having such a shape. Alternatively, the R-data signal may include a pulse width modulated signal. For example, the R-data signal may have a variable high-level section which is varied during the R-data period according to gradation.

As the R-data signal is applied to the pixel, in case that the liquid crystal is maintained to have a predetermined array, the red lamp is turned on. Therefore, the liquid crystal having a predetermined transmittance is tinted with red.

Following the R-data programming period, the G-frame begins. The G-frame includes a G-reset period and a G-data programming period. The reset voltage is applied during the G-reset period. The reset voltage has a square wave form having a level of ΔVr. That is, during the G-reset period, the reset voltage with a voltage level of ΔVr higher than the voltage level ΔVd of a G-data signal is applied to the liquid crystal tinted with red, so that the liquid crystal is initialized by the reset voltage. When the liquid crystal is sufficiently initialized, it can be programmed by a G-data signal.

The initialized liquid crystal has a sufficiently low transmittance. The G-data signal is applied to the initialized liquid crystal, and the green lamp is turned on.

Next, the B-frame begins, initializing the liquid crystal programmed with G-Data. During a B-reset period, the reset voltage is applied to initialize the liquid crystal. Here, the reset voltage has a level of ΔVr.

As described above, in the field sequential driving method according to an embodiment of the present invention, a reset voltage with a voltage level higher than the voltage level of the data signal is applied to initialize the liquid crystal. Consequently, the initialization of the liquid crystal is performed quickly and thus the reset period for the initialization is shortened.

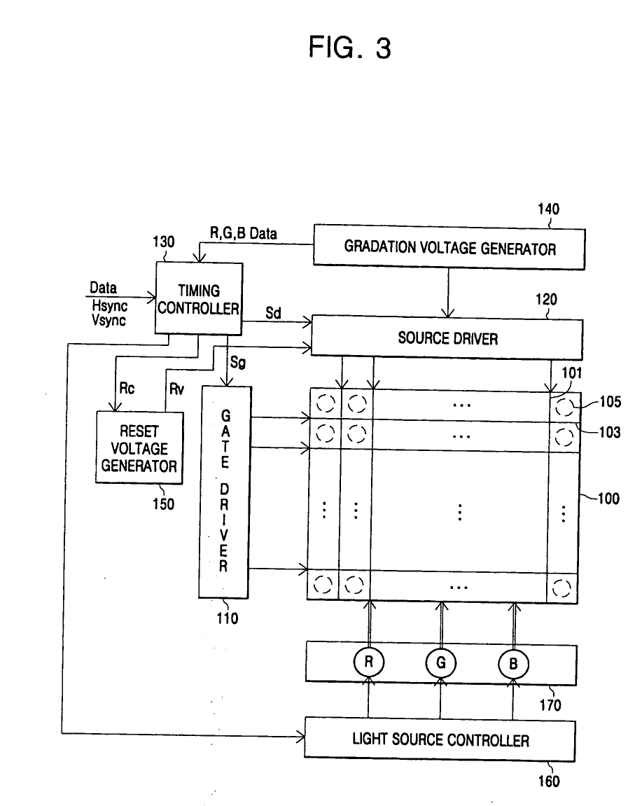

FIG. 3 is a block diagram of a field sequential LCD performing initialization of a liquid crystal according to a second embodiment of the present invention. As shown, the field sequential LCD according to an embodiment of the present invention includes: an LCD panel 100; a gate driver 110 for supplying a scan signal to the LCD panel 100; a source driver 120 for supplying a data signal and a reset voltage to the LCD panel 100; a timing controller 130 for receiving digital video data and synchronization signals; a gradation voltage generator 140 connected between the timing controller 130 and the source driver 120; a reset voltage generator 150 for generating a reset voltage; a light source controller 160 for driving a plurality of lamps; and a light emitter 170 for emitting light responsive to a light control signal of the light source controller 160.

The LCD panel 100 includes a plurality of pixels 105 formed in regions where a plurality of data lines 101 intersect a plurality of scan lines 103. Each pixel 105 includes a liquid crystal to display an image.

The gate driver 110 supplies a scan signal to a pixel 105 through a corresponding scan line 103. When the scan signal is applied to the pixel 105, transistors of the pixel 105 are selectively turned on, thereby readying the pixel 105 to receive the data signal.

The source driver 120 supplies a data signal to the pixel 105 through a corresponding data line 101. The liquid crystal of the pixel 105 is aligned depending on the data signal applied between a pixel electrode and a common electrode, and the gradation of an image is represented according to the alignment state of the liquid crystal. Further, the source driver 120 supplies a reset voltage to the pixel 105 to initialize the liquid crystal of the pixel 105.

The timing controller 130 receives digital video data, a vertical synchronization signal Vsync, and a horizontal synchronization signal Hsync. Then, the timing controller 130 classifies the received digital video data into red, green and blue data, and outputs the classified data to the gradation voltage generator 140. Further, the timing controller 130 generates a scan control signal Sg for controlling the gate driver 110 to output the scan signals in sequence, and a data control signal Sd for controlling the source driver to output the data signal and the reset voltage to the pixel 105.

The gradation voltage generator 140 receives the red, green and blue data from the timing controller 130, and outputs data modulated based on a lookup table to the source driver 120. Then, the source driver 120 receives, samples, and latches the modulated data on the basis of the data control signal Sd in order to supply the modulated data to the data lines.

The reset voltage generator 150 generates the reset voltage having a higher voltage level than the data signal. The reset voltage Rv is supplied to the source driver 120 which selects either the reset voltage Rv output from the reset voltage generator 150 or the modulated data output from the timing controller 130 based on the data control signal Sd. For example, the reset voltage Rv is selected and supplied to the data line during the reset period.

Further, the reset voltage generator 150 includes a DC-DC converter or a bootstrap circuit to generate the reset voltage to have a higher voltage level than the data signal.

The light source controller 160 turns a red lamp R, a green lamp G, and a blue lamp B on and off in sequence during one frame, as controlled by the timing controller 130. For example, the red lamp R is turned on and off, then the green lamp G is turned on and off, and then the blue lamp B is turned on and off, in sequence. Here, the reset period for initializing the liquid crystal is set to start when a lamp is turned off and end when the next lamp is turned on.

As described above, the reset voltage Rv having a higher voltage level than the data signal is applied to initialize the liquid crystal during the reset period. In one embodiment, a separate reset voltage generator is provided to generate the reset voltage having a higher voltage level than the data signal and supply the reset voltage to the source driver. Also, the source driver selects either the data signal or the reset voltage based on the timing controller and supplies the selected signal to the liquid crystal.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A method for driving a field sequential liquid crystal having three sub-frames, the method comprising:
activating the three sub-frames in sequence, wherein each sub-frame activation comprising:
applying a reset voltage having a first voltage level to initialize the liquid crystal;
applying a data signal having a second voltage level that is lower than the first voltage level to the liquid crystal; and
emitting light to the liquid crystal.

2. The method according to claim 1, wherein the applying a reset voltage is performed during a reset period, and the applying a data signal and the emitting light are performed during a data programming period.

3. The method according to claim 2, wherein the reset voltage comprises a square wave.

4. The method according to claim 1, wherein the reset voltage comprises at least two square waves during the reset period.

5. The method according to claim 3, wherein the data signal comprises a square wave.

6. The method according to claim 4, wherein the data signal comprises a pulse width modulated signal.

7. A field sequential liquid crystal display (LCD) comprising:
a LCD panel for displaying an image;
a gate driver for supplying a scan signal to the LCD panel;
a source driver for supplying a data signal to the LCD panel during a data programming period, and supplying a reset voltage to the LCD panel during a reset period;
a timing controller for receiving digital video data and synchronization signals, and generating a control signal and the data signal for displaying an image in response to the synchronization signal;
a gradation voltage generator for receiving the data signal from the timing controller and supplying data modulated based on a lookup table to the source driver;
a reset voltage generator for generating the reset voltage having a higher voltage level than the data signal in response to the control signal generated by the timing controller, and supplying the reset voltage to the source driver;
a light source controller for generating a light control signal in response to the control signal generated by the timing controller; and
a light emitter having a plurality of lamps for emitting light in response to the light control signal of the light source controller.

8. The field sequential LCD according to claim 6, wherein the source driver supplies one of the data signal or the reset voltage to the LCD panel in response to the data control signal generated by the timing controller.

9. The field sequential LCD according to claim 6, wherein the reset voltage generator comprises a DC-DC converter to generate the reset voltage having a higher voltage level than the data signal.

10. The field sequential LCD according to claim 6, wherein the reset voltage generator comprises a bootstrap circuit to generate the reset voltage having a higher voltage level than the data signal.

11. The field sequential LCD according to claim 8, wherein the reset voltage comprises a square wave.

12. The field sequential LCD according to claim 8, wherein the reset voltage comprises at least two square waves during the reset period.

13. The field sequential LCD according to claim 6, wherein the data signal comprises a square wave.

14. The field sequential LCD according to claim 6, wherein the data signal comprises a pulse width modulated signal.

15. A method for driving a field sequential liquid crystal, the method comprising:
initializing the liquid crystal by applying a reset signal to the liquid crystal;
programming the liquid crystal by applying a data signal having a voltage level lower than voltage level of the reset signal to the liquid crystal and emitting light to the liquid crystal.

16. The method according to claim 15, wherein the reset signal comprises a square wave.

17. The method according to claim 15, wherein the reset signal comprises at least two square waves during the reset period.

18. The method according to claim 15, wherein the data signal comprises a square wave.

19. The method according to claim 15, wherein the data signal comprises a pulse width modulated signal.
